(19) United States
(12) Patent Application Publication
(10) Pub. No.: US 2013/0241422 A1
(43) Pub. Date: Sep. 19, 2013

(54) CHRISTMAS STRIP LIGHTING CONTROL SYSTEM

(71) Applicants: Wen-Jui CHIANG, Tainan City (TW); Chen-Kun HUANG, Kaohsiung City (TW); Yao-Ju CHEN, Kaohsiung City (TW)

(72) Inventors: Wen-Jui CHIANG, Tainan City (TW); Chen-Kun HUANG, Kaohsiung City (TW); Yao-Ju CHEN, Kaohsiung City (TW)

(21) Appl. No.: 13/418,693

(22) Filed: Mar. 13, 2012

(51) Int. Cl. H05B 37/02

(52) U.S. Cl. 315/186

(57) ABSTRACT

A Christmas strip lighting control system, having a main structure composed of a switching power supply and a programmable lighting control system, and operates in coordination with a micro controller unit to form the Christmas strip lighting control system applicable for use in LED strip lighting sets providing diversified output types. The present invention not only reduces the number of components needed, achieving more extensive adaptability and more convenient production to benefit protecting the green environment, but also provides accurate control over output power, enables more stable effectiveness, reduces failure rate to the minimum and prolongs serviceable life.

### BACKGROUND OF THE INVENTION

(a) Field of the Invention

The present invention provides a “Christmas strip lighting control system,” which primarily uses a “micro controller unit” paired with a “PWM (Pulse Width Modulation) control voltage and electric current-like switching power supply,” and is applicable for use LED (Light Emitting Diode) strip lighting sets providing diversified output types, enabling more precise control over the output, and further improving production efficiency and reducing production cost.

(b) Description of the Prior Art

In these times of global warming and shortage in energy resources, and the upswing in demand and prices, there has been the general trend for modern technology to focus on saving energy and reducing carbon emission. Hence, improving the usable effectiveness of energy resources and further reducing cost are of comparative importance.

Referring to FIG. 4, which shows an adapter connection schematic of a LED Christmas strip lighting currently on sale in the present market, which is provided with a plurality of tandem connected LED light sets, and each tandem connected LED light set can be of a different color (such as: red, green, blue color . . . and so on). However, each tandem connected LED light set must include a tandem connected current limiter. Hence, when connecting each LED light set, an increase in the number of LED light sets results in a corresponding increase in the number of resistances needed, thereby creating senseless waste in energy resources.

In light of the aforementioned short comings of the prior art structure, the inventor of the present invention, having accumulated years of experience in related art and design, and through extensive exploration and study of sample trials, as well as repeated modification and improvement, has ultimately designed a new improved Christmas strip lighting control system.

### SUMMARY OF THE INVENTION

The objective of the present invention is to use a “micro controller unit” paired with a “PWM control voltage and current-like switching power supply” for application in LED strip lighting sets providing diversified output types to enable more precise control over output power, and further improve production efficiency and reduce production cost.

In order to achieve the aforementioned objective, the present invention provides a Christmas strip lighting control system, comprising a switching power supply, a micro controller unit and a LED strip lighting set. The micro controller unit is provided with a pulse width modulation controller and a strip lighting control current limiter. The pulse width modulation controller controls the voltage and electric current of the switching power supply, moreover, the pulse width modulation controller controls whether each strip lighting of the LED strip lighting set is lit or not through use of the strip lighting control current limiter.

In the Christmas strip lighting control system of the present invention, the switching power supply is provided with a bridge rectifier, a transformer and a rectifier.

In the Christmas strip lighting control system of the present invention, the pulse width modulation controller is a PWM circuit.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a circuit schematic diagram (1) of the present invention.

FIG. 2 is a circuit schematic diagram (2) of the present invention.

FIG. 3 is a adapter connection schematic of a Christmas strip lighting of the present invention.

FIG. 4 is a adapter connection schematic of a Christmas strip lighting of the prior art.

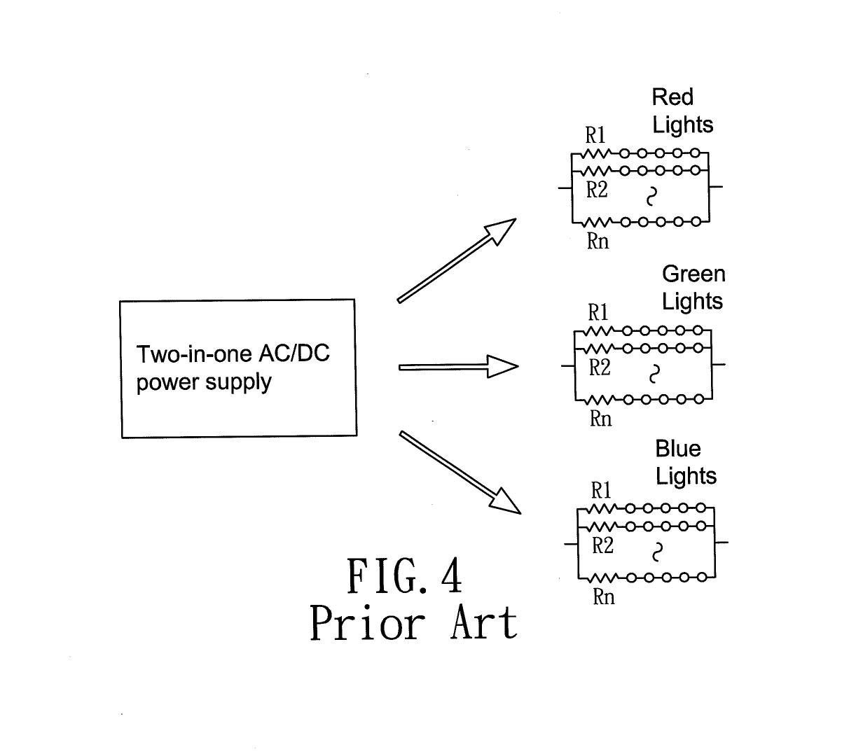

### DETAILED DESCRIPTION OF THE PREFERRED EMBODIMENTS

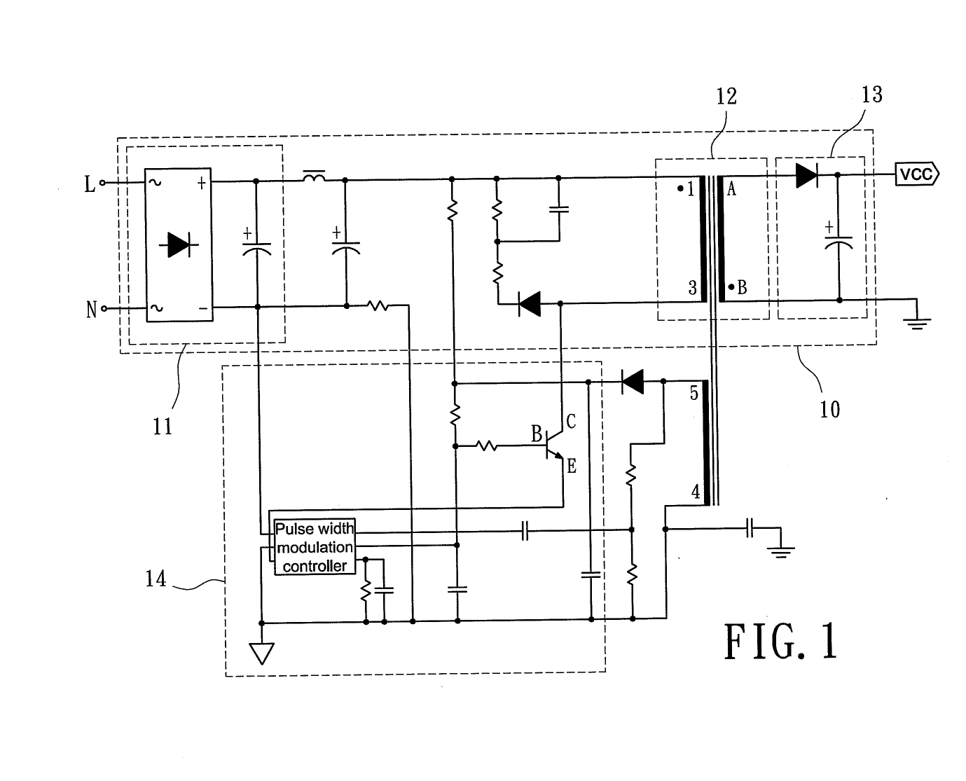

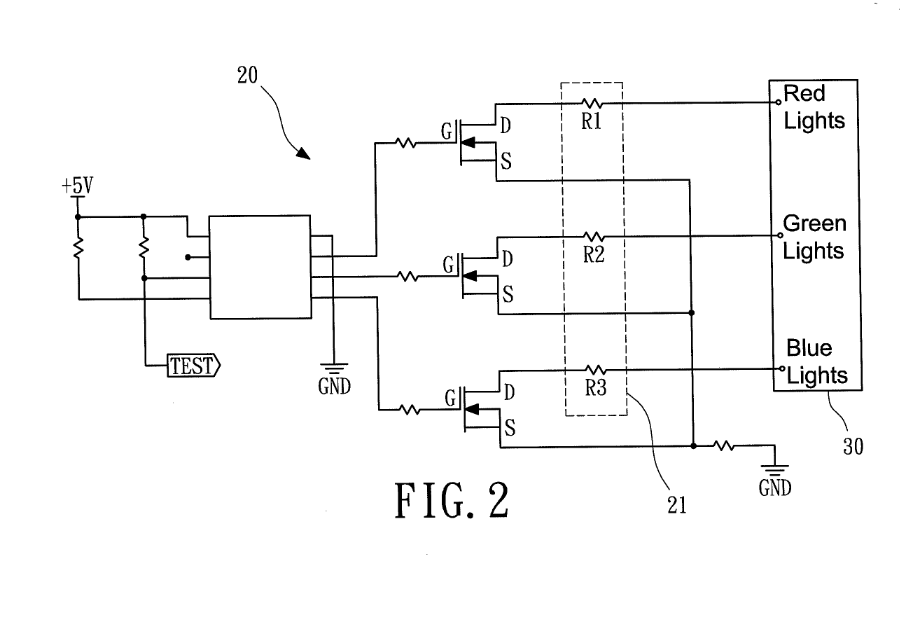

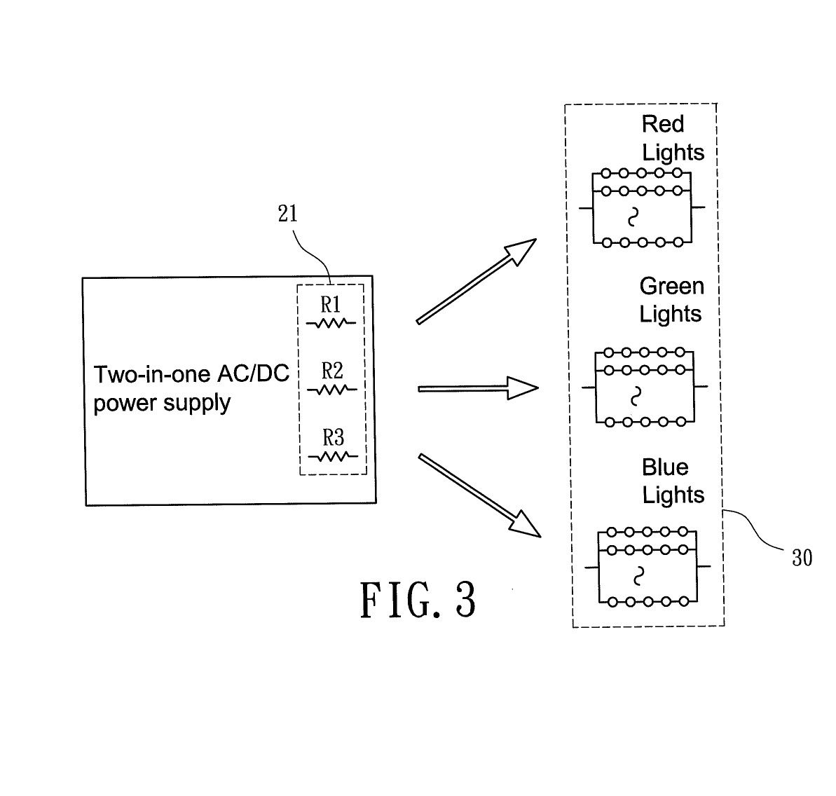

Referring to FIG. 1, FIG. 2 and FIG. 3, which show a Christmas strip lighting control system of the present invention, provided with a switching power supply (SPS for short) (10), a micro controller unit (MCU for short) (20) and a LED strip lighting set (30).

The switching power supply (10) comprises a bridge rectifier (11), a transformer (12) and a rectifier (13). The micro controller unit (20) comprises a pulse width modulation controller (14) and a strip lighting control current limiter (21), wherein the pulse width modulation controller (14) can be a PWM circuit.

The main structure of the present invention primarily comprises the switching power supply (10) assembled from the bridge rectifier (11), the transformer (12) and the rectifier (13), and operates in coordination with the pulse width modulation controller (14) of the micro controller unit (20), thereby achieving the protective condition to enable timely adjustment of the strip lighting control current limiter (21) for diverse states of the LED strip lighting set (30) providing different color schemes (such as: red, green, blue color . . . and so on).

The pulse width modulation controller (14) of the present invention can be a PWM control voltage and current-like power supply, and with the micro controller unit (20) operating in coordination with the pulse width modulation controller (14), the micro controller unit (20) is able to control the entire behavior of the circuit, and outputs signals to instruct the pulse width modulation controller (14) to individually control whether each strip lighting of the LED strip lighting set (30) is lit or not lit. For example: red, green or blue, color . . . and so on, strip lighting of the LED strip lighting set (30) can be individually controlled to successively light up or simultaneously light up, thereby enabling only one strip lighting control current limiter (21) to be provided for the LED strip lighting set (30) to produce every kind of single color scheme (see FIG. 3), and achieving the economic benefit of energy conservation and environmental protection.

Furthermore, the present invention is applicable for use in the LED strip lighting set (30) providing diversified output types, to achieve precise control over output power, enable more stable effectiveness, reduce failure rate to the minimum and prolong serviceable life. Moreover, in the present invention there is no need to series connect current limiters in each of the LED strip lighting sets (30), thus providing a simple structure, which is able to improve production efficiency and reduce the total production cost.

In addition, the following comparative tables together further highlight the evident advancement in effectiveness provided by the present invention compared to structures of the prior art. Because the magnitude of error in the voltage output of the switching power supply (10) is ±5%≈±10%, this variable factor is the main reason resulting in the uneven brightness in the LED light set.

TABLE 1
Comparing the adapter connection method of the present
invention with a Christmas strip lighting of the prior art

| | New Model | Prior Art |
|---|---|---|
| | (24 V) adapter | Model (24 V) adapter |
| | connection method | connection method |
| LED strip lighting | Required: strip | Not required: strip lighting |
| management | lighting Vf requires | matched with resistance |
| | classification | |
| Resistance processing | 3 | 25 |
| quantity | | |
| Resistance | 20 Bins | 16 Bina |
| classification | | |
| Power source-power | Max: 3.9 W | Max: 4.5 W |
| output | Avg: 3.6 W | Avg: 3.6 W |
| | Min: 3.3 W | Min: 2.8 W |
| Production process | simple and accurate | complicated and relatively |
| | | inaccurate |
| Product cost | manufacturer's cost | end product supplier cost |
| | increased | reduced |
| Total cost | relatively low | relatively high |

TABLE 2
Resistance matching for prior art structures
24 V was used as the input voltage, matched with a resistance to obtain a fixed
electric current for the lighting strip, then 23 V, 25 V were used to measure the new
electric current value.

| R | | VCC | | VCC | | VCC | G, B | | VCC | | VCC | | VCC |
|---|---|---|---|---|---|---|---|---|---|---|---|---|---|
| LED | | 23 | | 24 | | 25 | LED | | 23 | | 24 | | 25 |
| Vf | mA | R (Ω) | mA | R (Ω) | mA | R (Ω) | Vf | mA | R (Ω) | mA | R (Ω) | mA | R (Ω) |
| 17.0 | 5.0 | 1200 | 5.8 | 1200 | 6.7 | 1200 | 14.0 | 5.6 | 1600 | 6.3 | 1600 | 6.9 | 1600 |
| 17.2 | 5.3 | 1100 | 6.2 | 1100 | 7.1 | 1100 | 14.2 | 5.5 | 1600 | 6.1 | 1600 | 6.8 | 1600 |
| 17.4 | 5.1 | 1100 | 6.0 | 1100 | 6.9 | 1100 | 14.4 | 5.4 | 1600 | 6.0 | 1600 | 6.6 | 1600 |
| 17.6 | 4.9 | 1100 | 5.8 | 1100 | 6.7 | 1100 | 14.6 | 5.3 | 1600 | 5.9 | 1600 | 6.5 | 1600 |
| 17.8 | 5.2 | 1000 | 6.2 | 1000 | 7.2 | 1000 | 14.8 | 5.5 | 1500 | 6.1 | 1500 | 6.8 | 1500 |
| 18.0 | 5.0 | 1000 | 6.0 | 1000 | 7.0 | 1000 | 15.0 | 5.3 | 1500 | 6.0 | 1500 | 6.7 | 1500 |
| 18.2 | 4.8 | 1000 | 5.8 | 1000 | 6.8 | 1000 | 15.2 | 5.2 | 1500 | 5.9 | 1500 | 6.5 | 1500 |
| 18.4 | 5.1 | 900 | 6.2 | 900 | 7.3 | 900 | 15.4 | 5.4 | 1400 | 6.1 | 1400 | 6.9 | 1400 |
| 18.6 | 4.9 | 900 | 6.0 | 900 | 7.1 | 900 | 15.6 | 5.3 | 1400 | 6.0 | 1400 | 6.7 | 1400 |
| 18.8 | 4.7 | 900 | 5.8 | 900 | 6.9 | 900 | 15.8 | 5.1 | 1400 | 5.9 | 1400 | 6.6 | 1400 |
| 19.0 | 4.7 | 850 | 5.9 | 850 | 7.1 | 850 | 16.0 | 5.4 | 1300 | 6.2 | 1300 | 6.9 | 1300 |
| 19.2 | 4.8 | 800 | 6.0 | 800 | 7.3 | 800 | 16.2 | 5.2 | 1300 | 6.0 | 1300 | 6.8 | 1300 |
| 19.4 | 4.8 | 750 | 6.1 | 750 | 7.5 | 750 | 16.4 | 5.1 | 1300 | 5.8 | 1300 | 6.6 | 1300 |
| 19.6 | 4.5 | 750 | 5.9 | 750 | 7.2 | 750 | 16.6 | 5.3 | 1200 | 6.2 | 1200 | 7.0 | 1200 |
| 19.8 | 4.6 | 700 | 6.0 | 700 | 7.4 | 700 | 16.8 | 5.2 | 1200 | 6.0 | 1200 | 6.8 | 1200 |
| 20.0 | 4.6 | 650 | 6.2 | 650 | 7.7 | 650 | 17.0 | 5.0 | 1200 | 5.8 | 1200 | 6.7 | 1200 |
| 20.2 | 4.3 | 650 | 5.8 | 650 | 7.4 | 650 | 17.2 | 5.3 | 1100 | 6.2 | 1100 | 7.1 | 1100 |
| 20.4 | 4.3 | 600 | 6.0 | 600 | 7.7 | 600 | 17.4 | 5.1 | 1100 | 6.0 | 1100 | 6.9 | 1100 |
| 20.6 | 4.4 | 550 | 6.2 | 550 | 8.0 | 550 | 17.6 | 4.9 | 1100 | 5.8 | 1100 | 6.7 | 1100 |
| 20.8 | 4.0 | 550 | 5.8 | 550 | 7.6 | 550 | 17.8 | 5.2 | 1000 | 6.2 | 1000 | 7.2 | 1000 |
| 21.0 | 4.0 | 500 | 6.0 | 500 | 8.0 | 500 | 18.0 | 5.0 | 1000 | 6.0 | 1000 | 7.0 | 1000 |
| | on the | | normal | | on the | | | on | | normal | | on the | |
| | low | | | | high | | | the | | | | high | |
| | side | | | | side | | | low | | | | side | |
| | | | | | | | | side | | | | | |

R_LED Maximum deviation value ±33%.
G_LED & B_LED Maximum deviation value ±17%

TABLE 3
Resistance matching for the present invention
A one-to-one adapter matching with the appropriate resistance was carried out, and
then integrated to form the minimum type of resistance.

| R | | VCC | | VCC | | VCC | G, B | | VCC | | VCC | | VCC |
|---|---|---|---|---|---|---|---|---|---|---|---|---|---|
| LED | | 23 | | 24 | | 25 | LED | | 23 | | 24 | | 25 |
| Vf | mA | R (Ω) | mA | R (Ω) | mA | R (Ω) | Vf | mA | R (Ω) | mA | R (Ω) | mA | R (Ω) |
| 17.0 | 30 | 200 | 30 | 230 | 31 | 260 | 14.0 | 60 | 150 | 59 | 170 | 61 | 180 |
| 17.2 | 31 | 190 | 30 | 230 | 30 | 260 | 14.2 | 59 | 150 | 61 | 160 | 60 | 180 |
| 17.4 | 29 | 190 | 30 | 220 | 30 | 250 | 14.4 | 61 | 140 | 60 | 160 | 59 | 180 |
| 17.6 | 30 | 180 | 30 | 210 | 30 | 250 | 14.6 | 60 | 140 | 59 | 160 | 61 | 170 |
| 17.8 | 31 | 170 | 30 | 210 | 30 | 240 | 14.8 | 59 | 140 | 61 | 150 | 60 | 170 |
| 18.0 | 29 | 170 | 30 | 200 | 30 | 230 | 15.0 | 62 | 130 | 60 | 150 | 59 | 170 |
| 18.2 | 30 | 160 | 31 | 190 | 30 | 230 | 15.2 | 60 | 130 | 59 | 150 | 61 | 160 |
| 18.4 | 31 | 160 | 29 | 190 | 30 | 220 | 15.4 | 58 | 130 | 61 | 140 | 60 | 160 |
| 18.6 | 29 | 150 | 30 | 180 | 30 | 210 | 15.6 | 62 | 120 | 60 | 140 | 59 | 160 |
| 18.8 | 30 | 140 | 31 | 170 | 30 | 210 | 15.8 | 60 | 120 | 59 | 140 | 61 | 150 |
| 19.0 | 31 | 130 | 29 | 170 | 30 | 200 | 16.0 | 58 | 120 | 62 | 130 | 60 | 150 |
| 19.2 | 29 | 130 | 30 | 160 | 31 | 190 | 16.2 | 62 | 110 | 60 | 130 | 59 | 150 |
| 19.4 | 30 | 120 | 31 | 150 | 29 | 190 | 16.4 | 60 | 110 | 58 | 130 | 61 | 140 |
| 19.6 | 31 | 110 | 29 | 150 | 30 | 180 | 16.6 | 58 | 110 | 62 | 120 | 60 | 140 |
| 19.8 | 29 | 110 | 30 | 140 | 31 | 170 | 16.8 | 56 | 110 | 60 | 120 | 59 | 140 |
| 20.0 | 30 | 100 | 31 | 130 | 29 | 170 | 17.0 | 60 | 100 | 58 | 120 | 62 | 130 |
| 20.2 | 31 | 90 | 29 | 130 | 30 | 160 | 17.2 | 58 | 90 | 62 | 110 | 60 | 130 |
| 20.4 | 29 | 90 | 30 | 120 | 31 | 150 | 17.4 | 62 | 90 | 60 | 110 | 58 | 130 |
| 20.6 | 30 | 80 | 31 | 110 | 29 | 150 | 17.6 | 60 | 90 | 58 | 110 | 62 | 120 |
| 20.8 | 31 | 70 | 29 | 110 | 30 | 140 | 17.8 | 58 | 80 | 62 | 100 | 60 | 120 |
| 21.0 | 29 | 70 | 30 | 100 | 31 | 130 | 18.0 | 63 | 80 | 60 | 100 | 58 | 120 |

R_LED current error was 30 ± 1 mA, 3% error.
G_LED & B_LED current error was 60 ± 2 mA, 3% error.

In conclusion. the present invention surely provides the above advantages, and has evident advancement in effectiveness when compared to prior art structures. Moreover, the present invention is characterized in having originality compared to similar products, and thus clearly complies with the essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A Christmas strip lighting control system, comprising a switching power supply, a micro controller unit and a LED (Light Emitting Diode) strip lighting set, wherein, the micro controller unit is provided with a pulse width modulation controller and a strip lighting control current limiter, the pulse width modulation controller controls the voltage and electric current of the switching power supply, and the pulse width modulation controller controls whether each strip lighting of the LED strip lighting set is lit or not through use of the strip lighting control current limiter.

2. The Christmas strip lighting control system according to claim 1, wherein the switching power supply is provided with a bridge rectifier, a transformer and a rectifier.

3. The Christmas strip lighting control system according to claim 1, wherein the pulse width modulation controller is a PWM (Pulse Width Modulation) circuit.

4. The Christmas strip lighting control system according to claim 2, wherein the pulse width modulation controller is a PWM circuit.
